(19) United States
(12) Patent Application Publication
(10) Pub. No.: US 2015/0248122 A1
(43) Pub. Date: Sep. 3, 2015

(54) Providing a Customized Programmable Logic Controller to a Customer

(71) Applicant: Siemens Aktiengesellschaft, Munchen (DE)

(72) Inventor: Victor Neal Norwood, Blountville, TN (US)

(21) Appl. No.: 14/428,459

(22) PCT Filed: Sep. 26, 2012
(86) PCT No.: PCT/US2012/057226

§ 371 Date: Mar. 16, 2015

(51) Int. Cl. G05B 19/05

(52) U.S. Cl. CPC G05B 19/056

(57) ABSTRACT

The disclosed embodiments relate to providing a customized programmable logic controller (“PLC”). A first order is received. The first order specifies a first subset of PLC components of a set of PLC components (184). A first PLC housing is selected from a plurality of PLC housings for the first subset of PLC components. The first PLC housing is of a minimal size necessary to accommodate the PLC components in the first subset. The PLC is caused to be assembled using the first PLC housing and the first subset of PLC components. The customized PLC is caused to be provided in response to the first order.

### BACKGROUND

A programmable logic controller (“PLC”), or programmable controller, is a digital computer used for automation of electromechanical processes, such as control of machinery on factory assembly lines, amusement rides, or light fixtures. PLCs are used in many industries and machines. Unlike general-purpose computers, the PLC is designed for multiple input and output arrangements, extended temperature ranges, immunity to electrical noise, and resistance to vibration and impact. Programs to control machine operation are typically stored in battery-backed-up or non-volatile memory. A PLC is an example of a hard real time system since output results must be produced in response to input conditions within a limited time, otherwise unintended operation will result.

The main difference from other computers is that PLCs are typically armored for severe conditions (such as dust, moisture, heat, cold) and have the facility for extensive input/output (I/O) arrangements to connect, for example, to sensors and actuators. PLCs may be capable of reading limit switches, analog process variables (such as temperature and pressure), and the positions of complex positioning systems. Some PLCs may use machine vision and/or may operate electric motors, pneumatic or hydraulic cylinders, magnetic relays, solenoids, or analog outputs. The input/output arrangements may be built into a simple PLC, or the PLC may have external I/O modules, which may be referred to as “signal modules,” attached to a computer network that plugs into the PLC.

Modular PLCs may include a chassis (also called a rack) into which are placed modules with different functions. The processor and selection of I/O modules are customized for the particular application. Several racks may be administered by a single processor, and may have thousands of inputs and outputs. A communications medium, such as a special high speed serial I/O link, may be used so that racks can be distributed away from the processor, reducing the wiring costs for large plants.

High volume PLCs are typically designed to address and suit the needs and applications of a majority of PLC customers, rather than to address and meet the needs and applications of individual PLC customers. High volume PLCS tend to be fairly standardized and include many features (in an effort to address and suit the needs and applications of the majority of PLC customers). As a result, high volume PLCS are often quite large, such that they take up a considerable amount of space (e.g., din-rail space). Although these high volume PLCs typically meet the needs and applications of PLC customers, some PLC customers may end up paying for features that they do not really need and/or require additional or different features not included in the standardized high volume PLCs.

### BRIEF SUMMARY

By way of introduction, the preferred embodiments described below include methods, systems, instructions, and computer readable media for providing a customized PLC.

In a first aspect, a method is provided for providing a customized PLC. The method includes receiving a first order. The first order specifies a first subset of PLC components of a set of PLC components. The method includes selecting a first PLC housing from a plurality of PLC housings for the first subset of PLC components. The selected first PLC housing is of a minimal size necessary to accommodate the PLC components in the first subset. The method also includes causing the PLC to be assembled using the first PLC housing and the first subset of PLC components. The method further includes causing the PLC to be supplied.

In a second aspect, a system is provided for providing a customized PLC. The system includes a database operable to store a set of PLC components, and a server operable to receive a first order that specifies a first subset of PLC components of the set of PLC components. The server is further operable to identify a first PLC housing from a plurality of PLC housings for the first subset of PLC components. The identified first PLC housing is of a minimal size necessary to accommodate the PLC components in the first subset. The server is further operable to cause the PLC to be assembled with the first subset of PLC components arranged within or on the first PLC housing. The server is further operable to cause the PLC to be provided in response to the first order.

In a third aspect, a non-transitory computer readable storage medium has stored therein data representing instructions executable by a programmed processor for providing a customized PLC. The storage medium includes instructions for (i) storing a set of PLC components; (ii) receiving a first order that specifies a first subset of PLC components of the set of PLC components; (iii) selecting a first PLC housing from a plurality of PLC housings, the first PLC housing being of a minimal size necessary to accommodate the PLC components in the first subset; and (iv) generating a PLC order that includes the first subset of PLC components arranged within or on the first PLC housing.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 depicts a block diagram of a system for providing a customized programmable logic controller according to one embodiment.

FIG. 2. depicts a plurality of exemplary PLC components.

FIG. 3 depicts an exploded perspective view of a customized programmable logic controller according to one embodiment.

FIG. 4 shows a flow chart depicting operation of the system of FIG. 1 according to one embodiment.

FIG. 5 shows a block diagram of a general computer system for use with the disclosed embodiments.

### DETAILED DESCRIPTION OF THE DRAWINGS AND PRESENTLY PREFERRED EMBODIMENTS

The disclosed embodiments relate to providing a customized PLC to a customer. Unlike high volume PLCs, which tend to be fairly standardized and include many features in an effort to address and suit the needs and applications of the majority of PLC customers, the disclosed embodiments aim to provide a PLC that is designed to address and meet the needs and applications of individual PLC customers. Accordingly, PLC customers only pay for those features or components that they really need. The disclosed embodiments also aim to provide a PLC that is as small as possible, such that it takes up as little space (e.g., din-rail space) as possible.

Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

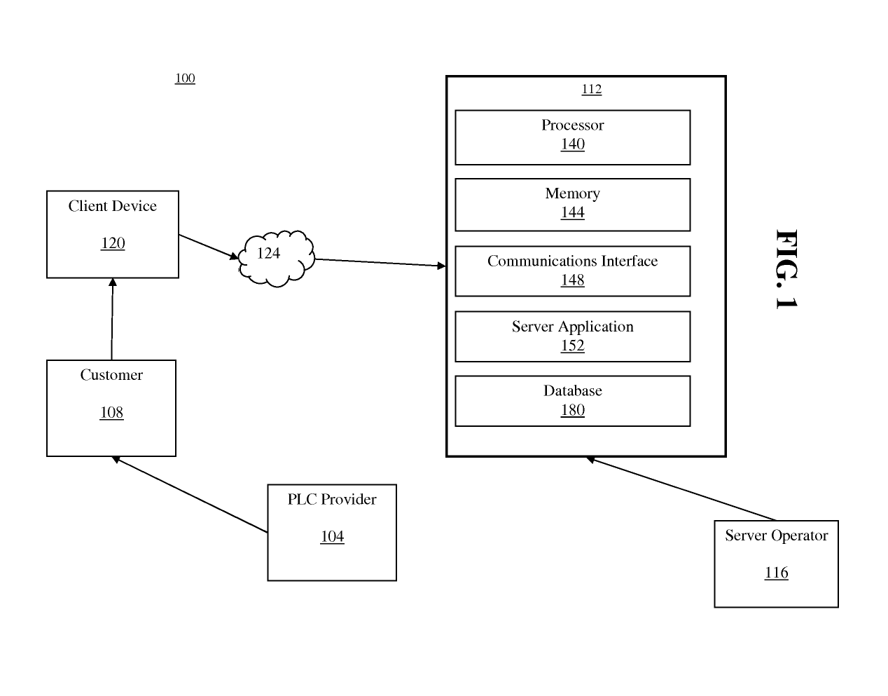

FIG. 1 shows a block diagram of a system 100 for providing a customized programmable logic controller (“PLC”) from a PLC provider 104 to a customer 108 of the PLC provider 104. The system 100 generally includes a platform or server 112 created or operated by, or otherwise associated with, a platform or server operator 116. The server 112 is coupled with or connected to a client device 120 associated with the customer 108 or a user associated with the customer 108 via a communication network 124. As used herein, the phrases “in communication” and “couple” include a direct connection or an indirect connection through one or more intermediate components. Such intermediate components may include hardware and/or software based components. The system 100 may include additional, different, or fewer components. For example, the system 100 may include additional PLC providers 104, customers 108 (of any of the PLC providers 104), servers 112, client devices 120 (associated with the same customer 108 and/or additional customers 108), networks 124, or combinations thereof. In one embodiment, each PLC provider 104 has a dedicated server 112.

The PLC provider 104 may be a manufacturer, supplier, distributor, retailer, provider, or combinations thereof, of PLCs. In one embodiment, the PLC provider 104 is an original manufacturer of PLCs, such as Siemens Industry, Inc. The customer 108 may be a new or returning (i.e., previous) customer, consumer, client, or other user of the PLC provider 104. The customer 108 may be an individual, a group, an organization (e.g., corporation), or other entity. The platform or server operator 116 may be the PLC provider 104 or may be different than, but associated with, the PLC provider 104.

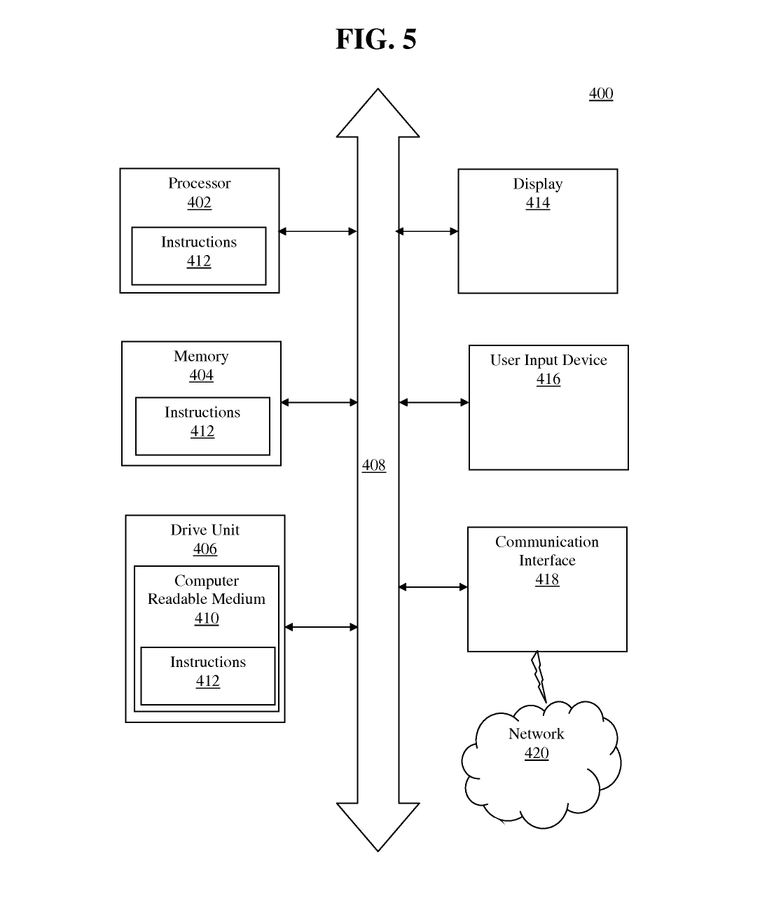

As shown in FIG. 1, the platform or server 112 generally includes a processor 140, a memory 144, a communications interface 148, and a server application 152. In other embodiments, the server 112 may include additional, different, or fewer components. In some embodiments, the server 112 may be located at, within, or proximate to a store, shop, warehouse, factory, office, plant, or other establishment of or associated with the PLC provider 104. In other embodiments, the server 112, and components thereof, may be partially or fully located within or be part of the client device 120. In one embodiment, the server 112 may be implemented as computer program logic or computer readable program code stored in the memory and/or storage of a computer, such as the computer 400 described below with respect to FIG. 5, and may be executable by one or more processors thereof to implement the disclosed functionality.

The processor 140 may be a general processor, a digital signal processor, ASIC, field programmable gate array, graphics processing unit, analog circuit, digital circuit, combinations thereof, or other now known or later developed processor. The memory 144 may be a volatile memory or a non-volatile memory. The memory 144 may include one or more of a read only memory (ROM), random access memory (RAM), a flash memory, an electronic erasable program read only memory (EEPROM), or other type of memory. The memory 144 may include an optical, magnetic (hard drive) or any other form of data storage device.

The communications interface 148 is provided to enable or facilitate electronic communication between the server 112 and the client device 120 via the network 124. The communications interface 148 may include one or more communication interfaces (e.g., TCP/IP ports), such as a communications interface devoted to sending and/or receiving signals, datagrams, data, packets, or information to/from the client device 120. The server application 152 may be stored on the memory 144 operated by the server 112 and loaded into the memory 144 of the server 112 to be executed by the processor 140.

In some embodiments, the client device 120 may be a mobile device, such as a smart phone, a mobile phone, a personal digital assistant (“PDA”), a tablet computer, a notebook computer, and/or any other known or later developed portable or mobile device, associated with the customer 108 or a user associated with the customer 108. In other embodiments, the client device 120 may be a desktop computer, workstation, or any other known or later developed non-portable or non-mobile client device associated with the customer 108 or a user associated with the customer 108.

In this embodiment, the client device 120 includes a processor, a memory, a display, and one or more input devices. The processor and the memory of the client device 120 may be similar to or different than the processor 140 and the memory 144 described above in connection with the server 112. The display may be a liquid crystal display (“LCD”) panel, light-emitting diode (LED) screen, thin film transistor screen, or other type of display. The one or more input devices may be one or more buttons, keypads, keyboards, mice, stylist pens, trackballs, rocker switches, touch pads, voice recognition circuits, touch screens, or other devices or components, or combinations thereof, for inputting data to the client device 120.

The network 124 may be a wireless network, wired network, or a combination of a wired and wireless network, such as an 802.11x compliant network, and may include publicly accessible networks, such as the Internet, private networks, or combinations thereof. The type and configuration of the communications network 124 are implementation dependent, and any type of communications network which facilitates the described communications between the server 112 and the client device 120, available now or later developed, may be used. The server 112 may communicate with the client device 120 using native or modified communications functionality of the device 120, such as using the short message service (“SMS”) or multimedia message service (“MMS”) text message protocol, the hypertext transport protocol (“HTTP”) via a web browser application provided by the device 120, the simple mail transfer protocol (“SMTP”), or other email communications protocol, via an email application, provided by the device 120, via a proprietary application (“app”) specifically installed on the device 120, which may use a proprietary or non-proprietary protocol, to implement the disclosed functionality, via the telephony functions of the device 120, such as via touch-tone or interactive voice response mechanisms, or combinations thereof.

The system 100 may further include a database 180 generally operable to store or maintain a list, catalog, table, or index of a plurality or set of PLC components 184 that the PLC provider 104 has or has made available or provided. In one embodiment, the database 180 may only store or maintain a list, catalog, table, or index of the plurality or set of PLC components that the PLC provider 104 indicates or has indicated are currently in-stock and/or readily accessible. The list, catalog, table, or index of PLC components may be created and/or updated by the PLC provider 104 and/or the server operator 116. In these embodiments, the database 180 is stored in the memory 144 of the server 112, but in other embodiments, the database 180 may be stored in the memory of the client device 120 or on another server or computer in communication with the server 112.

The plurality of PLC components 184 provided by or available from the PLC provider 104 may be selected or chosen to be included in the customized PLC, as will be described in greater detail below. The plurality or set 184 of PLC components generally includes one or more types of power supply circuit boards, one or more types of processor circuit boards, one or more types of input/output circuit boards, one or more types of signal boards, one or more types of communications ports, one or more types of one or more other components, or combinations thereof. The plurality of PLC components 184 may be manufactured and/or assembled by the PLC provider 104, other manufacturers, other entities, or combinations thereof. In some embodiments, the PLC components of the plurality of PLC components may be pre-built or pre-assembled. In other embodiments, the PLC components of the plurality of PLC components may be built or assembled after an order has been received.

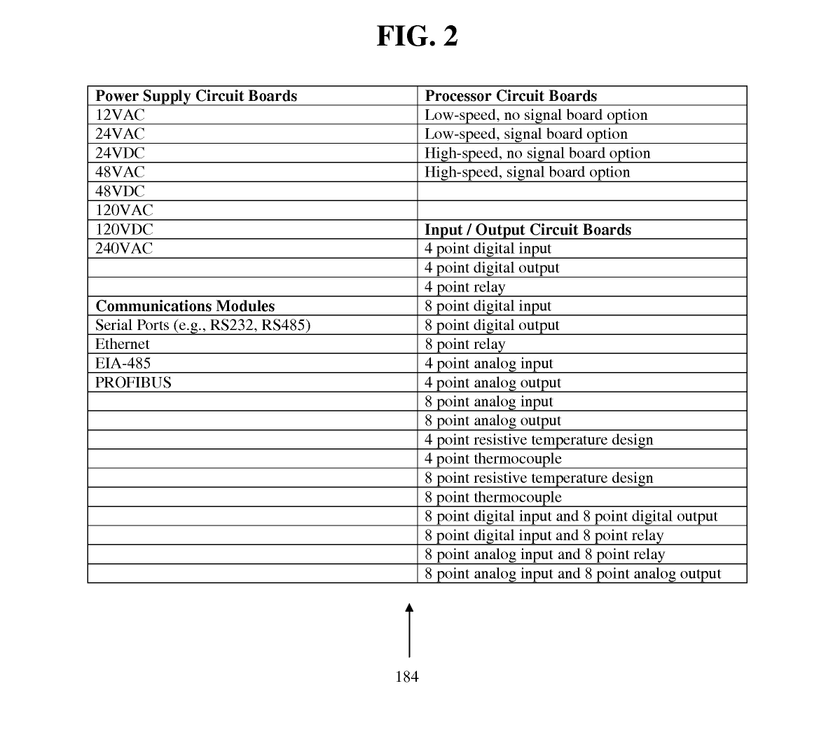

As shown in FIG. 2, which depicts a plurality or set of exemplary PLC components, the plurality of PLC components 184 includes two or more different types of power supply circuit boards, two or more different types of processor circuit boards, two or more different types of input/output circuit boards, two or more different types of signal boards, and two or more different types of communications ports. In other words, the plurality of PLC components includes at least two or more types of each of these PLC components. In one embodiment, the plurality of PLC components 184 includes two or more different types of power supply circuit boards, processor circuit boards, and input/output circuit boards. In some embodiments, the plurality of PLC components 184 may include other components, such as one or more input devices (e.g., a keyboard, a mouse, a display, etc.), a memory (e.g., Read Only Memory, Read Access Memory), an annex card, a programming device (used to create and/or enter the program into the memory of the PLC), other components, or combinations thereof.

Power supply circuit boards are generally operable to supply different levels of AC or DC power to other components in the PLC. The type of power supply circuit board generally determines the level (e.g., V) and type (e.g., AC or DC) of power supplied or provided to the other components. Different types of power supply circuit boards may be used to supply more or less and/or different types of power. The two or more types of power supply circuit boards may include power supply circuit boards that supply 12V, 24V, 48V, 120V, 240V, another amount of V, or combinations thereof, of AC or DC power. In one embodiment, only two types of power supply circuit boards are provided: 24VDC and 120VAC power supply circuit boards, which are power levels commonly utilized in PLCs. In another embodiment, eight types of power supply circuit boards are provided: 12VDC, 24VDC, 48VDC, 120VDC, 24VAC, 48VAC, 120VAC, and 240VAC power supply circuit boards. In other embodiments, different, fewer, or additional types of power supply circuit boards may be provided.

Processor circuit boards each generally include a microprocessor, memory chip, and other integrated circuits to control logic, monitoring, and communications of or for the PLC. The processor circuit boards generally determine the availability of various programming functions, different sizes of application logic, and/or memory, as well as the processing speed. Different types of processor circuit boards may be used to increase or decrease the availability of various programming functions, different sizes of application logic, and/or memory, as well as increase or decrease the processing speed. The two or more types of processor circuit boards may include low, medium, high, or other speed processor circuit boards that have or do not have the option of utilizing a signal board. In one embodiment, four types of processor circuit boards are provided: a low speed processor circuit board with no option of using a signal board, a high-speed processor circuit board with no option of using a signal board, a low speed processor circuit board with an option of using a signal board, and a high speed processor circuit board also with the option of using a signal board. In other embodiments, different, additional, or fewer types of processor circuit boards may be provided.

Input/output circuit boards are generally operable to provide a physical connection between the PLC and other equipment coupled to the PLC, such as sensors, actuators, field devices, etc. The input/output circuit boards each provide a pre-determined count of inputs and/or outputs. The two or more types of input/output circuit boards may include one or more types of input circuit boards (i.e., in which no outputs are provided), one or more types of output circuit boards (i.e., in which no inputs are provided), or combinations thereof. Additionally or alternatively, the two or more types of input/output circuit boards may include one or more types of analog circuit boards, one or more types of digital circuit boards, one or more types of thermocouple (“TC”) circuit boards, one or more types of resistive temperature design (“RTD”) circuit boards, one or more types of Relay circuit boards, or combinations thereof. The two or more types of input/output circuit boards may include input/output circuit boards having any number of inputs and/or outputs, such as, for example, 2, 4, 8, inputs and/or outputs. Any combination of these different types of circuit boards may be used.

In one embodiment, the following types of input/output circuit boards are provided: a 4 point digital input circuit board, a 4 point digital output circuit board, a 4 point relay circuit board, an 8 point relay circuit board, an 8 point digital input circuit board, an 8 point digital output circuit board, a 4 point analog input circuit board, a 4 point analog output circuit board, an 8 point analog input circuit board, an 8 point analog output circuit board, a 4 point RTD circuit board, an 8 point RTD circuit board, a 4 point TC circuit board, an 8 point TC circuit board, an 8 point digital input and 8 point digital output circuit board, an 8 point digital input and 8 point relay circuit board, an 8 point analog input and 8 point relay circuit board, and an 8 point analog input and 8 point analog output circuit board. In other embodiments, additional, fewer, or different types of input/output circuit boards may be provided.

The communications modules or ports generally facilitate or enable communication between the PLC and other computers (e.g., a computer running a supervisory control and data acquisition system), systems, or devices (e.g., HMI). The different types of communications modules generally facilitate or enable different communications, such as communications using different protocols, between the PLC and the other computers, systems or devices.

In some embodiments, two or more different types of communications ports are provided. The two or more different types of communications ports may include serial ports (e.g., RS232, RS485), Ethernet, EIA-485, PROFIBUS, other communications ports or modules, or combinations thereof. In one embodiment, all of these different types of communications ports are provided. In another embodiment, only one of these types of communications ports is provided, such as, for example, RS485.

Signal boards are generally used to expand the number of inputs/outputs in a PLC without affecting the physical size of the PLC. The different types of signal boards generally facilitate or enable different levels of expansion (with regard to the inputs/outputs in the PLC). In some embodiments, two or more different types of signal boards are provided. The two or more different types of signal boards may include one or more types of input circuit boards, one or more types of output circuit boards, or combinations thereof. The two or more different types of signal boards may, additionally or alternatively, include one or more types of analog circuit boards, one or more types of digital circuit boards, one or more types of thermocouple (“TC”) circuit boards, one or more types of resistive temperature design (“RTD”) circuit boards, or combinations thereof. The two or more types of signal boards may have any number of inputs and/or outputs, such as, for example, 2, 4, 8, inputs and/or outputs. The two or more different types of signal boards may, additionally or alternatively, include signal boards designed or configured to convert signals, such as RS 485, RS 232, and/or other signals. Any combination of these different types of circuit boards may be used.

The system 100 further includes an interface that allows or facilitates the building or customization and ordering of a PLC for the customer 108. The customer interface is provided by software in the form of a Web Browser (e.g., Firefox, Internet Explorer) or a plug in or proprietary application built into or operating on an operating system of the client device 120. In one embodiment, the customer interface is a website, such as the website of or for the PLC provider 104. In another embodiment, the customer interface is a mobile application operated by or associated with the PLC provider 104. The customer interface is in communication with or coupled to the server 112 via the network 124. More specifically, the customer interface is in communication with or coupled to the database 180. As such, the customer interface has access to the list, catalog, table, or index of the plurality or set of PLC components 184 provided by or available from the PLC provider 104.

The customer 108 or the user associated with the customer 108, such as a user ordering, paying for, and/or customizing the PLC for the customer 108, may, using the display and/or the one or more input devices (e.g., the keyboard, the mouse) of the device 120 open, start, or otherwise initiate the customer interface (e.g., the website of or for the PLC provider 104) to begin the ordering process. The customer 108 or the user associated with the customer 108 may automatically, when the customer interface is opened or in response to a request to the server 112 from or by the client device 120, be provided, via the customer interface, with the entire list of the PLC components provided by or available from the PLC provider 104 at one time or incrementally (e.g., the list may be broken down by type(s) of PLC components) and/or questions relating to the needs and requirements of the customer 108 to assist in selecting or choosing the appropriate (e.g., best) PLC components (i.e., the PLC components that will best suit or match the needs of the customer 108). Exemplary questions include: “how many inputs do you need?” “how many outputs do you need?” “what level of CPU performance do you need?” “how many ports do you need?” “what type of user input power do you need?” Additional, fewer, or different questions may be provided.

The customer 108 or the user associated with the customer 108 may, using the display and/or the one or more input devices of the device 120, select or choose a subset of PLC components from the full or partial list that best suit or match the needs of the customer 108. Alternatively, the server 112 may select or determine a subset of PLC components that best suit or match the needs of the customer 108 based on, in response to, or as a function of the answers to the questions provided to the customer 108 or the user associated with the customer 108 by the server 112 and/or default PLC components. For example, if the customer or user is asked “how many inputs do you need?” and “how many outputs do you need?” and the customer responds with “4” and “4,” respectively, the server 112 may determine that the customer 108 needs a 4 point input and 4 point output circuit board. In some embodiments, the customer 108 or the user associated with the customer 108 may select or choose a portion of the subset of the PLC components and the server 112 may select or determine a remaining portion of the subset of the PLC components based on the answers to the questions and/or default PLC components, such as, for example, a 24 VDC power supply circuit board.

The subset of PLC components chosen or selected, by the customer 108 or the user associated therewith and/or the server 112, for the customer 108, may include a type of power supply circuit board, a type of processor circuit board, one or more input/output circuit boards comprised of one or more types of input/output circuit boards, a type of signal board, one or more types of communications ports, one or more types of one or more other components, or combinations thereof. In one embodiment, the subset of PLC components is the same as the set of PLC components. In some embodiments, the subset of PLC components includes a type of power supply circuit board, a type of processor circuit board, one or more input/output circuit boards comprised of one or more types of input/output circuit boards, and one or more types of communications ports. The subset of PLC components may include any number of input/output circuit boards, such as, for 2, 4, 6, or 8 input/output circuit boards. The number of input/output circuit boards may include any number of types of input/output circuit boards. In the example in which the subset of PLC components includes 8 input/output circuit boards, the subset may include, for example, 1, 2, 4, 6, or 8 different types of input/output circuit boards. The PLC components in the subset of PLC components are selected or chosen from the set or plurality of PLC components 184, as described above.

The provider 104 may, in some embodiments, provide the customer 108 or the user associated therewith, via the customer interface, the option of including some type of brand labeling on the final customized PLC. The customer 108 or the user associated therewith may have the option of choosing or selecting from a number of standard or default labels and/or uploading or providing a custom label to the provider 104. By providing this option, the PLC provider 104 may provide the customer 108 with a PLC that better suits or matches the needs of the customer 108.

The provider 104 may, in some embodiments, provide the customer 108 or the user associated therewith, via the customer interface, the option of reserving or setting aside extra space in the final customized PLC. This extra space may be used to add PLC components, such as one or more input/output circuit boards, at a later time.

After the subset of PLC components has been selected or chosen, by the customer 108 or the user associated therewith and/or the server 112, for the customer 108, the customer 108 or the user associated therewith may submit or transmit his/her/its PLC order to the server 112 via the network 124. In turn, the server 112 is operative to receive the PLC order from the customer 108 or the user associated therewith via the network 124. The PLC order specifies or details the subset of PLC components selected or chosen for the customer 108 that best suit or match the needs of the customer 108.

Once the PLC order has been received, the server 112 is operative to select or identify a PLC housing from a plurality of PLC housings based on or as a function of the subset of PLC components. The plurality of PLC housings generally includes two or more different sized PLC housings. In one embodiment, the plurality of PLC housings includes three different PLC housings, each PLC housing being of a different size. For example, the plurality of PLC housings may include a micro housing, a mini housing, and a medium-to-large sized housing. In other embodiments, the plurality of PLC housings includes any other number of different sized PLC housings, such as 5, 10, 20, or 100 different sized PLC housings. In any event, each PLC housing of the plurality of PLC housings has, includes, or provides a plurality of slots. Each slot of the plurality of slots may be adapted or configured to receive and vertically maintain or support therein any one of the one or more power supply circuit boards, one or more processor circuit boards, or one or more input/output circuit boards of the set of PLC components 184. In some embodiments, some or all of the PLC housings may lack a backplane but may instead include a plurality of surface mount connectors to help couple the PLC components, particularly the one or more power supply circuit boards, the one or more processor circuit boards, and the one or more input/output circuit boards, together. In other embodiments, some or all of the PLC housings have a backplane and may or may not include the plurality of surface mount connectors.

The PLC housing is selected or identified by the processor of the server 112 without input from the customer 108 or the user associated therewith. The processor of the server 112 makes this selection or identification based on the plurality of PLC housings and the subset of PLC components, and, more particularly, based on the size (height, width, depth) of the available PLC housings and the number and size of the PLC components in the subset chosen or selected for the customer 108.

The selected or identified PLC housing is of a minimal size necessary to house or accommodate the PLC components of the subset of PLC components chosen or selected by the customer 108. In other words, the selected or identified PLC housing is the smallest-sized housing that will house, receive, fit, or otherwise accommodate the PLC components chosen or selected for the customer 108 as matching or suiting the needs of the customer 108. More specifically, the selected or identified PLC housing is the smallest-sized housing in which the power supply circuit board, the processor circuit board, and the one or more input/output circuit boards may be vertically arranged in the PLC housing. This might be, for example, the PLC housing with just enough slots to receive and vertically support the power supply circuit board, the processor circuit board, and the one or more input/output circuit boards. The PLC housing selected to accommodate one subset of PLC components may be the same as or different than the PLC housing selected to accommodate another, different subset of PLC components. As an example, when a first subset that includes a power supply circuit board, a processor circuit board, a communications port, and an input/output circuit board is specified, a first PLC housing of the plurality of PLC housings is selected or identified as being of a minimal size necessary to house or accommodate the PLC components in the first subset, and when a second subset, different from the first subset, that includes a power supply circuit board, a processor circuit board, a communications port, and 8 input/output circuit boards, a second PLC housing of the plurality of PLC housings different from (e.g., bigger than) the first PLC housing is selected or identified as being of a minimal size necessary to house or accommodate the PLC components in the second subset.

Once the PLC housing has been selected or identified and included in the PLC order for the customer 108, the server 112 is operative to cause the PLC to be assembled using the selected PLC housing and the PLC components in the subset. The server 112 may generate or create and transmit or send the completed PLC order, which includes the selected PLC housing and the PLC components in the subset, to the PLC provider 104 or another entity on behalf of or associated with the PLC provider 104 for production. The server 112 may, additionally, instruct the PLC provider 104, or another entity on behalf of or associated with the

PLC provider, to assemble the PLC with or using the selected housing and the subset of PLC components. This may involve instructing the PLC provider 104 or the other entity to arrange some of the PLC components, such as the power supply circuit board, the processor circuit board, the one or more input/output circuit boards, or combinations thereof, within the selected PLC housing. More particularly, the server 112 instructs the PLC provider 104 or the other entity to arrange these components vertically in the selected PLC housing, such as, for example, in the plurality slots in the selected PLC housing. The server 112 may instruct the PLC provider 104 or the other entity to arrange or build the other PLC components, such as the signal board, the one or more communications modules, on (e.g., on the outside of) or within the selected PLC housing.

Based on the PLC order and/or these instructions from the server 112, the customized PLC may then be assembled or formed by the PLC provider 104 or another entity on behalf of or associated with the PLC provider 104. In other words, the customized PLC may be assembled or formed with or using the selected housing and the subset of PLC components selected for the customer 108. The PLC components in the subset of PLC components are arranged or built within, into, or on the selected housing. Some components, such as the power supply circuit board, the processor circuit, the one or more input/output circuit boards, or combinations thereof, are arranged within the selected PLC housing. More particularly, these components are arranged vertically in the selected PLC housing, such as, for example, in the plurality of slots in the PLC housing. Accordingly, the PLC housing substantially surrounds these components. Other components, such as the signal board, the one or more communications port(s), may be built into or arranged on (e.g., on the outside of) or within the selected PLC housing.

Once the PLC has been assembled or formed, the server 112 is operative to cause the PLC to be supplied or provided to the customer 108 in or via any known and/or later developed manner. The PLC or brick supplied or provided to the customer 108 is not only customized to include only the PLC features or components that suit or match the needs of the customer 108, but also possesses as small of a footprint (i.e., it takes up as little space) as possible.

At any time in the ordering process (e.g., when the PLC has been assembled and/or shipped), the server 112 may generate or create, and provide to the customer 108, an order identifier (e.g., confirmation or tracking number) that may be used by the customer 108 to check the status of or track the order. The order identifier may be provided to the customer 108 via the customer interface or in some other way via the network 124 or another network.

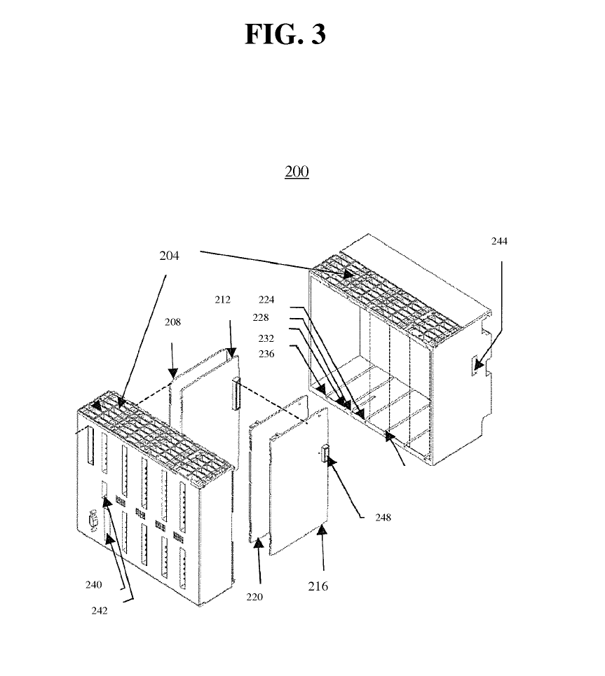

FIG. 3 illustrates an exemplary customized PLC 200 that may be provided or supplied to the customer 108. As shown in FIG. 3, the PLC 200 includes a PLC housing 204 selected or chosen to house or provide a subset of PLC components chosen or selected for the customer 108. In this embodiment, the subset of PLC components includes a power supply circuit board 208, a processor circuit board 212, a first input/output circuit board 216 (e.g., an 8 point digital input board), and a second input/output circuit board 220 of a different type than the first board 216 (e.g., an 8 point digital output board). The PLC housing 204 was chosen or selected based on the subset of PLC components and is of a minimal size necessary to house or accommodate the PLC components in the subset.

The PLC housing 204 includes a plurality of slots 224, 228, 232, 236 generally configured or adapted to receive and vertically support or maintain any of the PLC components of the subset. In this embodiment, the power supply circuit board 208 is arranged or inserted into the slot 224, the processor circuit board 212 is arranged or inserted into the slot 228, the first input/output circuit board 216 is arranged or inserted into the slot 232, and the second input/output circuit board 220 is arranged or inserted into the slot 236. In other embodiments, the boards 208, 212, 216, 220 may be arranged differently, such as, for example, in different slots. The PLC housing 204 further includes or defines a plurality of ports 240, 242, 244 adapted or configured to receive external devices, connectors (e.g., an energy source connector, a plug connector of an expansion input/output module), and/or modules (e.g., a memory module). As shown in FIG. 3, the PLC 200 further includes a plurality of surface mount connectors 248 configured to communicatively couple the boards 212, 216, 220, and 224 together or to one another.

The PLC 200 thus includes only those PLC components chosen or selected for the customer 108 (i.e., only those PLC components identified as matching the needs of the customer 108), but does so while taking up a minimal amount of space.

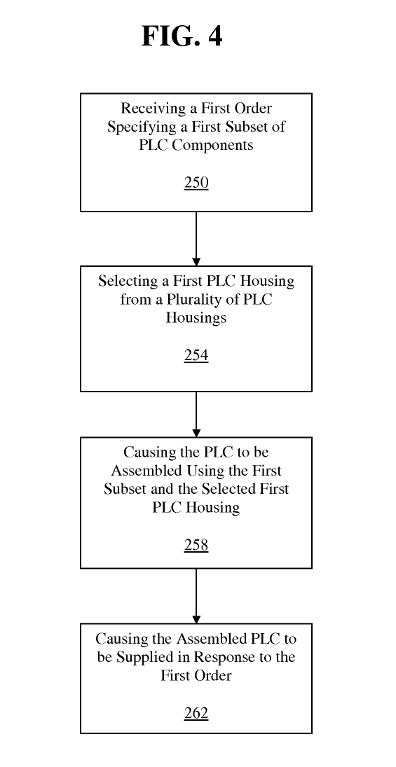

FIG. 4 depicts a flow chart showing operation of a method for providing a customized PLC to the customer 108. In one embodiment, the system 100 includes a server 112, implemented as a computer having a processor and a memory coupled therewith.

The operation includes receiving, such as via execution by the processor of first logic stored in the memory, by the computer, a first order (block 250). The first order may be received from the customer 108 or may be received from another user associated with or acting on behalf of the customer 108. The first order specifies a first subset of PLC components of a set of PLC components 184. The PLC components in the first subset of PLC components are selected for the customer 108 by the customer 108 or the user associated therewith and/or the server 112.

The plurality or set of PLC components 184 generally includes one or more types of power supply circuit boards, one or more types of processor circuit boards, one or more types of input/output circuit boards, one or more types of signal boards, one or more types of communications ports, one or more types of one or more other components, or combinations thereof. In the exemplary embodiments, the plurality of PLC components 184 includes two or more different types of power supply circuit boards, two or more different types of processor circuit boards, two or more different types of input/output circuit boards, two or more different types of signal boards, and two or more different types of communications ports. In other words, in the exemplary embodiments, the plurality of PLC components 184 includes at least two or more types of each of these PLC components. In one embodiment, the plurality of PLC components 184 includes two or more different types of power supply circuit boards, processor circuit boards, and input/output circuit boards. In some embodiments, the plurality of PLC components 184 may include other components, such as one or more input devices (e.g., a keyboard, a mouse, a display, etc.), a memory (e.g., Read Only Memory, Read Access Memory), an annex card, a programming device (used to create and/or enter the program into the memory of the PLC), other components, or combinations thereof. The plurality of PLC components 184 may be manufactured by the PLC provider 104, other manufacturers, or combinations thereof. In some embodiments, the PLC components of the plurality of PLC components may be pre-built or pre-assembled. In other embodiments, the PLC components of the plurality of PLC components may be built or assembled after an order has been received.

The first subset of PLC components chosen or selected, by the customer 108 or the user associated therewith and/or the server 112, for the customer 108, may include a type of power supply circuit board, a type of processor circuit board, one or more input/output circuit boards comprised of one or more types of input/output circuit boards, a type of signal board, one or more types of communications ports, one or more types of one or more other components, or combinations thereof. In some embodiments, the subset of PLC components includes a type of power supply circuit board, a type of processor circuit board, one or more input/output circuit boards comprised of one or more types of input/output circuit boards, and one or more types of communications ports. The subset of PLC components may include any number of input/output circuit boards, such as, for 2, 4, 6, or 8 input/output circuit boards. The number of input/output circuit boards may include any number of types of input/output circuit boards. In the example in which the subset of PLC components includes 8 input/output circuit boards, the subset may include, for example, 1, 2, 4, 6, or 8 different types of input/output circuit boards. The PLC components in the subset of PLC components are selected or chosen from the set or plurality of PLC components 184, as described above.

The operation further includes selecting, such as via execution by the processor of second logic stored in the memory, by the computer, a first PLC housing from a plurality of PLC housings (block 254). The selecting is based on or as a function of the subset of PLC components. The selected first PLC housing is of a minimum size necessary to accommodate and/or house the PLC components in the first subset. The selecting is performed by the processor of the server 112 without input from the customer 108 and/or the user associated therewith placing the first order. The processor of the server 112 makes this selection or identification based on the plurality of PLC housings and the subset of PLC components, and, more particularly, based on the size (height, width, depth) of the available PLC housings and the number and size of the PLC components in the subset chosen or selected for the customer 108.

Selecting generally includes selecting the PLC housing from two or more different-sized PLC housings. In one embodiment, selecting includes selecting the PLC housing from three different-sized PLC housings. In other embodiments, selecting includes selecting the PLC housing from more than three-different sized PLC housings, such as, for example, 5, 10, 20, or 100 different sized PLC housings.

The operation further includes causing, such as via execution by the processor of third logic stored in the memory, by the computer, the PLC to be assembled using or with the first subset of PLC components and the PLC housing (block 258), and causing, such as via execution by the processor of fourth logic stored in the memory, by the computer, the PLC to be supplied or provided in response to the first order (block 262).

Causing the PLC to be assembled may include causing PLC components, such as the power supply circuit board, the processor circuit board, and one or more input/output circuit boards, to be arranged vertically in the first PLC housing (such as, for example, in the plurality of slots provided in the first PLC housing). Causing the PLC to be assembled may include causing other PLC components, such as the signal board or the one or more communications modules, to be built into or arranged on (e.g., on the outside of) or within the first PLC housing. Causing the PLC to be supplied or provided in response to the first order may include causing the fully assembled, customized PLC to be supplied or provided to the customer 108 in response to the first order (placed by the customer 108 or a user associated therewith).

The operation may, in some embodiments, further include receiving a second order specifying a second subset of PLC components. The second order may be received from the customer 108, the user associated with the customer 108, or another customer 108. The second subset of PLC components may be the same as or different than the first subset of PLC components. In other words, the second subset of PLC components may include the same PLC components as the first subset, or may include additional, fewer, or different PLC components than the first subset. Any number of additional subsets of PLC components (e.g., third, fourth, and so on, subsets of PLC components) may be received from the customer 108 and/or other customers 108.

The operation may, in some embodiments, further include selecting a second PLC housing from the plurality of PLC housings. The second PLC housing is of a minimal size necessary to accommodate the PLC components in the second subset. When the second subset of PLC components is different than the first subset of PLC components and/or the customer 108 (or the user associated therewith) wishes to have the option of expanding the PLC at some point in the future, selecting includes selecting a second PLC housing from the plurality of PLC housings, the second PLC housing being a different size than the first PLC housing. The second PLC housing may be bigger or larger than the first PLC housing or may be smaller than the first PLC housing. When, however, the second subset of PLC components is the same as the first subset of PLC components, selecting includes selecting a second PLC housing from the plurality of PLC housings, the second PLC housing being the same size as the first PLC housing.

Referring to FIG. 5, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above, such as the system 100 or a component thereof (e.g., the server 112), may be a computer system 400 or a component in the computer system 400. The computer system 400 may implement a programmable logic controller, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 5, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 5, the computer system 400 may also include a disk or optical drive unit 406. The disk drive unit 406 may include a computer-readable medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof, and may be representative of the network 124 in FIG. 1. The wireless network may be a Modbus network, cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

I claim:

1. A computer implemented method of providing a customized programmable logic controller (“PLC”), the method comprising:
receiving (250), by a processor, a first order specifying a first subset of PLC components of a set of PLC components (184);
selecting (254), by the processor, a first PLC housing from a plurality of PLC housings, the first PLC housing being of a minimal size necessary to accommodate the PLC components in the first subset;
causing (258), by the processor, the PLC to be assembled using the first PLC housing and the first subset of PLC components; and
causing (262), by the processor, the assembled PLC to be supplied in response to the first order.

2. The computer implemented method of claim 1, further comprising:
receiving a second order specifying a second subset of PLC components of the set of PLC components (184), the second subset being different from the first subset; and
selecting a second PLC housing from the plurality of PLC housings, the second PLC housing being of a minimal size necessary to accommodate the PLC components in the second subset, the second PLC housing being different from the first PLC housing.

3. The computer implemented method of claim 1, wherein the set of PLC components (184) comprises at least two of a power supply circuit board, a processor circuit board, an input/output circuit board, a signal board, and a communications module.

4. The computer implemented method of claim 1, wherein the set of PLC components (184) comprises two or more types of each of a power supply circuit board, a processor circuit board, an input/output circuit board, a signal board, and a communications module.

5. The computer-implemented method of claim 4, wherein the first subset of PLC components comprises a type of power supply circuit board, a type of processor circuit board, and a type of input/output circuit board, the type of each being selected from the respective two or more types in the set of PLC components.

6. The computer-implemented method of claim 5, wherein causing the PLC to be assembled comprises causing the power supply circuit board, the processor circuit board, and the input/output circuit board to be arranged vertically in the first PLC housing.

7. The computer-implemented method of claim 6, wherein the first PLC housing includes a plurality of slots configured to receive and support the power supply circuit board, the processor circuit board, and the input/output circuit board vertically in the first PLC housing.

8. The computer-implemented method of claim 1, wherein the plurality of PLC housings comprises at least three PLC housings each being of a different size.

9. The computer-implemented method of claim 1, wherein selecting the first PLC housing comprises selecting the first PLC housing without input from a customer (108) providing the first order.

10. The computer implemented method of claim 1, wherein the first subset of PLC components is selected by a customer (108) providing the first order.

11. The computer implemented method of claim 1, further comprising providing a list of the set of PLC components (184) to a customer (108).

12. A system (100) for providing a customized programmable logic controller (“PLC”), the system (100) comprising:
a database (180) operable to store a set of PLC components (184); and
a server (112) operable to receive a first order specifying a first subset of PLC components of the set of PLC components (184);
wherein the server (112) is further operable to identify a first PLC housing from a plurality of PLC housings for the first subset of PLC components, the first PLC housing being of a minimal size necessary to accommodate the PLC components in the first subset,
wherein the server (112) is further operable to cause the PLC to be assembled with the first subset of PLC components arranged within or on the first PLC housing, and
wherein the server (112) is further operable to cause the PLC to be provided in response to the first order.

13. The system of claim 12, wherein the set of PLC components (184) comprises two or more types of each of a power supply circuit board, a processor circuit board, an input/output circuit board, a signal board, and a communications module.

14. The system of claim 13, wherein the first subset of PLC components comprises a type of power supply circuit board, a type of processor circuit board, and a type of input/output circuit board, the type of each being selected from the respective two or more types in the set of PLC components (184).

15. The system of claim 12, wherein the server (112) is operable to identify the first PLC housing from the plurality of PLC housings comprising at least three PLC housings each being of a different size.

16. The system of claim 12, wherein the server (112) is operable to identify the first PLC housing from the plurality of PLC housings without input from a customer (108) providing the first order.

17. In a non-transitory computer-readable storage medium that stores instructions executable by one or more processors to provide a customized programmable logic controller (“PLC”), the instructions comprising:
storing a set of PLC components (184);
receiving a first order specifying a first subset of PLC components of the set of PLC components (184);
selecting a first PLC housing from a plurality of PLC housings, the first PLC housing being of a minimal size necessary to accommodate the PLC components in the first subset; and
generating a PLC order that includes the first subset of PLC components arranged within or on the first PLC housing.

18. The non-transitory computer-readable storage medium of claim 17, wherein selecting the first PLC housing comprises selecting the first PLC housing without input from a customer (108) providing the first order.

19. The non-transitory computer-readable storage medium of claim 17, wherein the set of PLC components (184) comprises two or more types of each of a power supply circuit board, a processor circuit board, an input/output circuit board, a signal board, and a communications module.

20. The non-transitory computer-readable storage medium of claim 17, wherein the first subset of PLC components comprises a type of power supply circuit board, a type of processor circuit board, and a type of input/output circuit board, the type of each being selected from the respective two or more types in the set of PLC components (184).
